(19) United States
(12) Patent Application Publication
(10) Pub. No.: US 2024/0313537 A1
(43) Pub. Date: Sep. 19, 2024

(54) CONTROL DEVICE AND CONTROL METHOD

(71) Applicant: IHI Corporation, Tokyo (JP)

(72) Inventors: Toshinobu ARIMURA, Tokyo (JP); Akinobu INAMURA, Tokyo (JP); Norihiro TAKAI, Tokyo (JP)

(73) Assignee: IHI Corporation, Tokyo (JP)

(21) Appl. No.: 18/598,005

(22) Filed: Mar. 7, 2024

(30) Foreign Application Priority Data
Mar. 17, 2023 (JP) 2023-042722

(51) Int. Cl. H02J 3/14; H02J 3/32

(52) U.S. Cl. CPC H02J 3/144; H02J 3/32; H02J 2310/52

(57) ABSTRACT

A control device supports self-sustaining operation of a smart grid which includes a power generation facility that performs power generation, a first storage battery that controls a voltage of the smart grid to be a target value, and a second storage battery that performs charge and discharge according to a charge and discharge command. The control device includes: an acquisition unit configured to acquire a generated power in the smart grid and a consumed power in the smart grid; a calculation unit configured to calculate a differential power that is a difference between the generated power and the consumed power; a determination unit configured to determine a charge and discharge power of the second storage battery using the differential power; and a control unit configured to transmit the charge and discharge command indicating the determined charge and discharge power of the second storage battery to the second storage battery.

### CROSS-REFERENCE TO RELATED APPLICATIONS

This application claims the benefit of priority from Japanese Patent Application No. 2023-042722, filed on Mar. 17, 2023, the entire contents of which are incorporated herein by reference.

### TECHNICAL FIELD

The present disclosure relates to a control device and a control method.

### BACKGROUND

In smart grids, systems to support self-sustaining operation are known. For example, Japanese Unexamined Patent Publication No. 2022-21371 describes a storage battery control device that enables self-sustaining operation of a natural energy power generation device. The invention described in Japanese Unexamined Patent Publication No. 2022-21371 uses a first power conversion device that controls an output voltage to be a target voltage, and a second power conversion device that controls an output current to be a target current. The invention described in Japanese Unexamined Patent Publication No. 2022-21371 determines a charge and discharge amount of the second power conversion device to absorb the output of the first power conversion device. That is, in the invention described in Japanese Unexamined Patent Publication No. 2022-21371, the charge and discharge amount of the second power conversion device fluctuates according to the output of the first power conversion device. In the invention described in Japanese Unexamined Patent Publication No. 2022-21371, the amount of voltage control by the first power conversion device becomes large.

### SUMMARY

In smart grids in which power generation is performed using renewable energy, self-sustaining operation may be performed. The power generation using renewable energy is easily influenced by the environment, such as weather and air flow rate, and in the power generation using renewable energy, a fluctuation in the voltage is likely to occur. If the fluctuation in the voltage is large, it becomes difficult to continue the self-sustaining operation. Therefore, there is a need for a system for stably operating the self-sustaining operation. The present disclosure will explain provision of a technology that enables a smart grid to stably execute self-sustaining operation.

A control device according to one aspect of the present disclosure is a control device that supports self-sustaining operation of a smart grid which includes a power generation facility that performs power generation using renewable energy, a first storage battery that controls a voltage of the smart grid to be a target value, and a second storage battery that performs charge and discharge according to a charge and discharge command. The control device includes: an acquisition unit configured to acquire a generated power in the smart grid and a consumed power in the smart grid; a calculation unit configured to calculate a differential power that is a difference between the generated power and the consumed power; a determination unit configured to determine a charge and discharge power of the second storage battery using the differential power; and a control unit configured to transmit the charge and discharge command indicating the determined charge and discharge power of the second storage battery to the second storage battery.

According to the present disclosure, it is possible to provide a technology that enables to stably operate self-sustaining operation of a smart grid.

### BRIEF DESCRIPTION OF THE DRAWINGS

FIG. 1 is a schematic configuration diagram of a control system according to an embodiment.

FIG. 2 is a block diagram illustrating a functional configuration of a control device.

FIG. 3 is a flowchart showing an example of a process of the control system.

FIG. 4 is a flowchart showing an example of storage battery charge remaining amount control.

FIG. 5 is a flowchart illustrating an example of self-sustaining side storage battery excess prevention control.

FIG. 6 is a flowchart showing another example of the process of the control system.

FIG. 7 is a diagram showing an example of a hardware configuration related to the control system.

### DETAILED DESCRIPTION

A control device according to one aspect of the present disclosure is a control device that supports self-sustaining operation of a smart grid which includes a power generation facility that performs power generation using renewable energy, a first storage battery that controls a voltage of the smart grid to be a target value, and a second storage battery that performs charge and discharge according to a charge and discharge command. The control device includes: an acquisition unit configured to acquire a generated power in the smart grid and a consumed power in the smart grid; a calculation unit configured to calculate a differential power that is a difference between the generated power and the consumed power; a determination unit configured to determine a charge and discharge power of the second storage battery using the differential power; and a control unit configured to transmit the charge and discharge command indicating the determined charge and discharge power of the second storage battery to the second storage battery.

A control method according to one aspect of the present disclosure is a control method executed by a control device that supports self-sustaining operation of a smart grid which includes a power generation facility that performs power generation using renewable energy, a first storage battery that controls a voltage of the smart grid to be a target value, and a second storage battery that performs charge and discharge according to a charge and discharge command. The control method includes: acquiring a generated power in the smart grid and a consumed power in the smart grid; calculating a differential power that is a difference between the generated power and the consumed power; determining a charge and discharge power of the second storage battery using the differential power; and transmitting the charge and discharge command indicating the determined charge and discharge power of the second storage battery to the second storage battery.

In the control device and the control method, in the self-sustaining operation of the smart grid, the charge and discharge power of the second storage battery is determined using the differential power that is the difference between the generated power and the consumed power. The charge and discharge by the second storage battery is performed according to the charge and discharge command indicating the determined charge and discharge power of the second storage battery. Through the charge and discharge of the second storage battery, the differential power is eliminated proactively. Fluctuation in the voltage of the smart grid due to the differential power is suppressed. As a result, the operation of the first storage battery that controls the voltage of the smart grid to be the target value is stabilized. As a result, it is possible to stably operate the self-sustaining operation of the smart grid.

The acquisition unit may acquire a charge level of the first storage battery and a charge level of the second storage battery. The control device may further include a correction unit configured to calculate a correction power for charging and discharging the second storage battery in accordance with a priority of the charge level of the first storage battery and the charge level of the second storage battery. The determination unit may determine the charge and discharge power of the second storage battery using the differential power and the correction power. According to such a configuration, the correction power calculated according to the charge level of the first storage battery and the charge level of the second storage battery is reflected in the charge and discharge power of the second storage battery. As a result, it becomes easy to control the charge level of the first storage battery and the charge level of the second storage battery through the charge and discharge of the second storage battery. As a result, it is possible to more stably operate the self-sustaining operation of the smart grid.

The acquisition unit may acquire a charge and discharge power of the first storage battery. The control device may further include a transfer unit configured to calculate a transfer power for charging and discharging the second storage battery in accordance with some or all of a power value exceeding a predetermined range in a case where the charge and discharge power of the first storage battery exceeds the predetermined range. The determination unit may determine the charge and discharge power of the second storage battery using the differential power and the transfer power. According to such a configuration, the transfer power calculated according to the charge and discharge power of the first storage battery exceeding the predetermined range is reflected in the charge and discharge power of the second storage battery. That is, some or all of the power value exceeding the predetermined range is transferred to the charge and discharge power of the second storage battery. As a result, the charge and discharge power of the first storage battery can be prevented from becoming excessive, and thus the operation of the first storage battery is stabilized. As a result, it is possible to more stably operate the self-sustaining operation of the smart grid.

The acquisition unit may acquire a charge level of the first storage battery and a charge level of the second storage battery. The control device may further include a limiting unit configured to limit the generated power by setting the consumed power as an upper limit value in a case where the charge level of the first storage battery and the charge level of the second storage battery are each equal to or higher than a predetermined value. According to such a configuration, in a case where the charge level of the first storage battery and the charge level of the second storage battery are equal to or higher than the predetermined value, the generated power is limited by setting the consumed power as an upper limit value. For example, when both the first storage battery and the second storage battery are fully charged, it becomes difficult to continue the self-sustaining operation. By limiting the generated power, it is possible to prevent the charge level of the first storage battery and the charge level of the second storage battery from being equal to or higher than the predetermined value. As a result, it is possible to more stably operate the self-sustaining operation of the smart grid.

Hereinafter, embodiments for carrying out the present disclosure will be described in detail with reference to the accompanying drawings. In the description of the drawings, the same elements are designated by the same reference signs, and duplicate description is omitted.

### [Control System]

A control system according to the present disclosure supports operation in a smart grid. The smart grid is connected to an external power system. During normal operation, the smart grid receives a power from the power system. During emergency operation such as a case where an accident occurs in the power system, the connection between the smart grid and the power system is cut off. In this case, the smart grid cannot receive a power from the power system. The control system supports self-sustaining operation for supplying a power in the smart grid independently from the power system. A first storage battery that controls a voltage in the smart grid and a second storage battery that performs charge and discharge are utilized in the control system. The control system performs charge and discharge of the second storage battery according to a difference between the generated power and the consumed power in the smart grid. As a result, fluctuation in the voltage in the smart grid which is controlled by the first storage battery is suppressed.

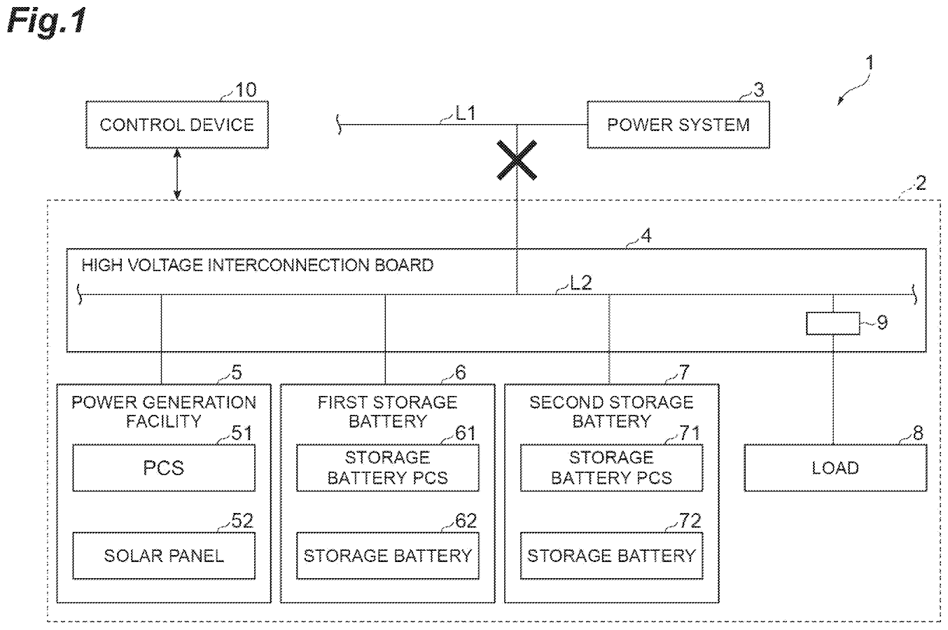

FIG. 1 is a schematic configuration diagram of a control system 1 according to an embodiment. The control system 1 is applied to self-sustaining operation in a smart grid 2. FIG. 1 shows a state in which a connection between the smart grid 2 and the power system 3 is cut off. The smart grid 2 is in a state in which it cannot receive a power from the power system 3 via an external high voltage line L1.

The smart grid 2 includes a high voltage interconnection board 4, a power generation facility 5, a first storage battery 6, a second storage battery 7, a load 8, and an instantaneous power meter 9.

The high voltage interconnection board 4 is connected to the power system 3 via the high voltage line L1 during normal operation. The high voltage interconnection board 4 is disconnected from the power system 3 via the high voltage line L1 during emergency operation. The high voltage interconnection board 4 is connected to the power generation facility 5, the first storage battery 6, the second storage battery 7, and the load 8 via a high voltage line L2. The instantaneous power meter 9 is provided on a path from the high voltage interconnection board 4 to the load 8. The high voltage interconnection board 4 supplies a power to each device in the smart grid 2.

The power generation facility 5 is a facility that performs power generation using renewable energy in the smart grid 2. The power generation facility 5 supplies the generated power in the smart grid 2. The unit of the generated power is, for example. [KW]. Examples of the renewable energy include, but are not limited to, a solar power or a wind power. The power generation facility 5 is, for example, a solar power generation facility. The power generation facility 5 includes a power conditioning system 51 (PCS) and a solar panel 52. The PCS 51 converts a direct current generated by the solar panel 52 into an alternating current.

The configuration of the PCS 51 may be either a centralized type or a distributed type. The centralized type is a configuration in which a single PCS 51 manages a plurality of solar panels 52 collectively. In the centralized type, the single PCS 51 can control a total of the generated power. The distributed type is a configuration in which a plurality of PCSs 51 manage a plurality of corresponding solar panels 52. In the distributed type, the total of the generated power can be controlled by starting or stopping the operation of the plurality of PCSs 51.

The first storage battery 6 controls a voltage of the smart grid 2 to be a target value. For example, the target value is, for example, a value similar to a voltage of the power system 3, or the like. The first storage battery 6 controls a voltage in the high voltage line L2 to be the target value. The first storage battery 6 stabilizes the voltage and frequency of the smart grid 2 by controlling the voltage. As a result, self-sustaining operation of the smart grid 2 becomes possible. The first storage battery 6 is, for example, a storage battery system. The first storage battery 6 includes a storage battery PCS 61 and a storage battery 62. The storage battery PCS 61 performs control of the storage battery 62 as a function of the PCS itself. In other words, the storage battery PCS 61 is a PCS that allows self-sustaining operation. For example, the storage battery PCS 61 controls the voltage of the smart grid 2 to be the target value. The storage battery PCS 61 converts a direct current of the storage battery 62 into an alternating current. The storage battery PCS 61 has a capacity of, for example, 500 kW of a charge power and 500 kW of a discharge power.

The storage battery 62 is a general term for devices that have the function of storing and supplying a power. For example, the storage battery 62 may be a general type of storage battery such as a lead storage battery, a lithium-ion secondary battery, an all-solid-state battery, a nickel-hydride storage battery, a nickel-cadmium storage battery, a nickel-iron storage battery, a nickel-zinc storage battery, a silver oxide-zinc storage battery, or a cobalt-titanium-lithium secondary battery. The storage battery 62 may be a liquid circulation type of storage battery such as a redox flow battery, a zinc-chlorine battery, or a zinc-bromine battery. The storage battery 62 may be a mechanical charge type of storage battery such as an aluminum-air battery, a zinc-air battery, or an air-iron battery. The storage battery 62 may be a high temperature operation type of storage battery such as a sodium-sulfur battery, a lithium-iron sulfide battery, an electron trap type of secondary battery, or a semiconductor secondary battery.

The second storage battery 7 performs charge and discharge according to a charge and discharge command. The second storage battery 7 suppresses the fluctuation in the voltage of the smart grid 2 through the charge and discharge. The second storage battery 7 is, for example, a storage battery system. The second storage battery 7 includes a storage battery PCS 71 and a storage battery 72. The storage battery PCS 71 performs control of the storage battery 72 in response to control from a control device 10. The storage battery PCS 71 converts a direct current of the storage battery 72 into an alternating current. The storage battery PCS 71 has a capacity of, for example, 500 kW of a charge power and 500 kW of a discharge power.

The storage battery 72 has a similar function to the storage battery 62. The storage battery 72 has a similar configuration to the storage battery 62. Although FIG. 1 shows a single second storage battery 7, a plurality of second storage batteries 7 may be provided. The second storage battery 7 may be a bidirectional electric vehicle (EV) charger including an EV storage battery. The bidirectional EV charger is a charger that allows charge and discharge with respect to an electric vehicle.

The first storage battery 6 and the second storage battery 7 can function as a power adjustment device when performing the adjustment of the transfer of a power between the smart grid 2 and the external power system 3 during normal operation. The first storage battery 6 can function as a self-sustaining operation side storage battery that adjusts the voltage in the smart grid 2 during emergency operation. The second storage battery 7 can function as a following-up side storage battery that adjusts the charge and discharge power in the smart grid 2 during emergency operation.

The load 8 consumes the power in the smart grid 2. Examples of the load 8 include, but are not limited to, factories, homes, public facilities, and hospitals. The instantaneous power meter 9 is provided corresponding to the load 8. The instantaneous power meter 9 measures the consumed power of the load 8. The unit of the consumed power is, for example, [KW]. Although FIG. 1 shows a single load 8 and a single instantaneous power meter 9, a plurality of loads 8 and a plurality of instantaneous power meters 9 may be provided.

The control device 10 supports the self-sustaining operation of the smart grid 2. The control device 10 controls or monitors each device in the smart grid 2. The control device 10 is, for example, an energy management system (EMS). The control device 10 is connected to the smart grid 2 to allow communication therebetween. The control device 10 may be a component of the smart grid 2.

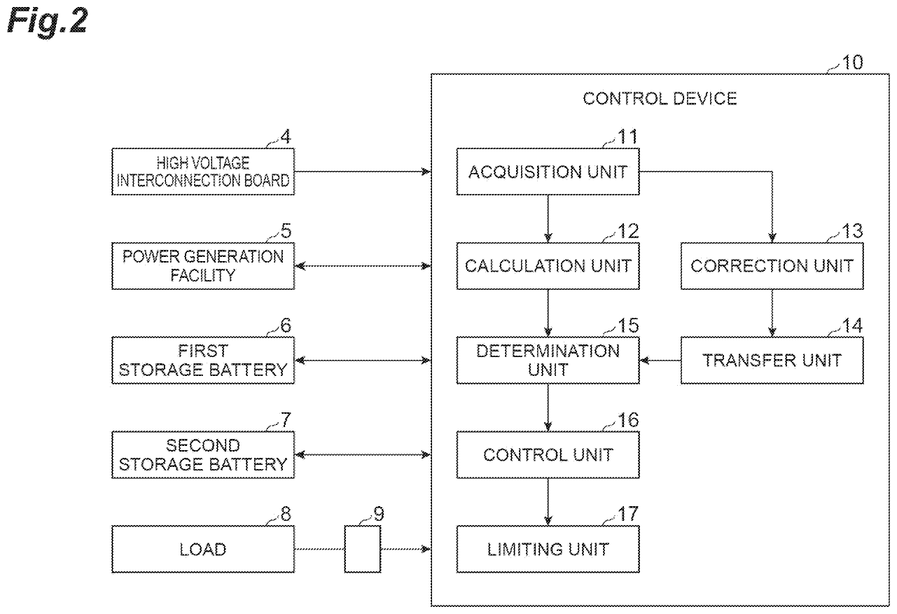

FIG. 2 is a block diagram illustrating a functional configuration of the control device 10. The control device 10 includes an acquisition unit 11, a calculation unit 12, a correction unit 13, a transfer unit 14, a determination unit 15, a control unit 16, and a limiting unit 17 as functional elements.

The acquisition unit 11 acquires information from each device in the smart grid 2. For example, the acquisition unit 11 acquires the state quantity of the high voltage interconnection board 4 from the high voltage interconnection board 4. The state quantity is a measured value of the voltage of the high voltage line L2. The acquisition unit 11 acquires the generated power in the smart grid 2. For example, the acquisition unit 11 acquires the generated power of the power generation facility 5 from the power generation facility 5. The acquisition unit 11 acquires the charge level and the charge and discharge power of the first storage battery 6 from the first storage battery 6. The charge level is also referred to as a state of charge (SOC). The charge level is expressed with a fully discharged state being 0% and a fully charged state being 100%. The acquisition unit 11 acquires the charge level of the second storage battery 7 from the second storage battery 7. The acquisition unit 11 may acquire the charge and discharge power of the second storage battery 7 from the second storage battery 7. The acquisition unit 11 acquires the consumed power in the smart grid 2. For example, the acquisition unit 11 acquires the consumed power of the load 8 from the instantaneous power meter 9. The acquisition unit 11 may acquire the consumed power of each of the plurality of loads 8 from each of the plurality of instantaneous power meters 9. The acquisition unit 11 may acquire the capacity of the storage battery PCS 61 of the first storage battery 6 and the capacity of the storage battery PCS 71 of the second storage battery 7 in advance. The acquisition unit 11 may acquire information on whether the configuration of the PCS 51 is either the centralized type or the distributed type in advance.

The calculation unit 12 calculates a differential power that is a difference between the generated power and the consumed power. For example, the calculation unit 12 calculates the differential power that is a difference between the generated power of the power generation facility 5 and a total value of the consumed power by the plurality of loads 8. In one example, the differential power is determined by the generated power minus the consumed power. That is, in a case where the differential power is a positive value, it can be said that the generated power is greater than the consumed power. On the other hand, in a case where the differential power is a negative value, it can be said that the consumed power is greater than the generated power.

The calculation unit 12 may calculate the differential power by adjusting the difference. For example, the calculation unit 12 may multiply the difference by a gain coefficient G. The gain coefficient may be G=1 in a case where there is no time difference between the generated power and the consumed power. The gain coefficient may be a value in the range of 0<G<1 in a case where there is a time difference between the generated power and the consumed power. Hunting is suppressed by reducing the gain of the difference. The calculation unit 12 may perform integral correction on the difference. For example, the calculation unit 12 may multiply the difference by a gain coefficient G and an integral coefficient. The calculation unit 12 may apply a rate limiter for limiting the rate of change to the difference.

The correction unit 13 calculates a correction power for charging and discharging the second storage battery 7 in accordance with a priority of the charge level of the first storage battery 6 and the charge level of the second storage battery 7. For example, the correction unit 13 classifies the charge level of the first storage battery 6 into any one of “high,” “medium,” and “low” using a threshold value. In one example, the correction unit 13 classifies the charge level of the first storage battery 6 into “high” in a case where it is higher than 75%, “medium” in a case where it is 50% to 75%, or “low” in a case where it is lower than 50%. Similarly, the correction unit 13 classifies the charge level of the second storage battery 7 into any one of “high.” “medium,” and “low” using a threshold value.

The correction unit 13 determines the priority using each classified charge level. The correction unit 13 calculates the correction power according to the priority. For example, the correction unit 13 determines a first priority, a second priority, and a third priority. The first priority, the second priority, and the third priority indicate higher priority in that order. The correction unit 13 determines the priority as the first priority in a case where the charge level of the first storage battery 6 is “low.” The correction unit 13 determines the priority as the second priority in a case where the charge level of the second storage battery 7 is “low.” The correction unit 13 determines the priority as the third priority in a case where the charge level of the first storage battery 6 is “high.”

In a case where the determined priority is the first priority, it can be said that the charge level of the first storage battery 6 is decreasing. The correction unit 13 calculates the discharge power of the second storage battery 7 as the correction power in order to compensate for the decrease in the charge level of the first storage battery 6. In one example, the correction unit 13 calculates the correction power using a first correction function in which the lower the charge level of the first storage battery 6, the greater the discharge power of the second storage battery 7. In one example, the first correction function can calculate a discharge power D1 of the second storage battery 7 in a case where the charge level of the first storage battery 6 is 45%. In another example, the first correction function can calculate a discharge power D2 of the second storage battery 7 in a case where the charge level of the first storage battery 6 is 40%. The relationship between the discharge power D1 and the discharge power D2 is discharge power D1<discharge power D2. The first correction function may be provided with a limit of the correction power. In one example, the first correction function may set the discharge power of the second storage battery 7 to a constant value in a case where the charge level of the first storage battery 6 is 25% or less.

In a case where the determined priority is the second priority, it can be said that the charge level of the second storage battery 7 has decreased. The correction unit 13 calculates the charge power of the second storage battery 7 as the correction power in order to compensate for the decrease in the charge level of the second storage battery 7. In one example, the correction unit 13 calculates the correction power using a second correction function in which the lower the charge level of the second storage battery 7, the greater the charge power of the second storage battery 7. In one example, the second correction function can calculate a charge power C1 of the second storage battery 7 in a case where the charge level of the second storage battery 7 is 20%. In another example, the second correction function can calculate a charge power C2 of the second storage battery 7 in a case where the charge level of the second storage battery 7 is 15%. The relationship between the charge power C1 and the charge power C2 is charge power C1<charge power C2.

In a case where the determined priority is the third priority, it can be said that the charge level of the first storage battery 6 is excessive. The correction unit 13 calculates the discharge power of the first storage battery 6 as the correction power in order to suppress the increase in the charge level of the first storage battery 6. In one example, the correction unit 13 calculates the correction power using a third correction function in which the higher the charge level of the first storage battery 6, the greater the charge power of the second storage battery 7. In one example, the third correction function can calculate a charge power C3 of the second storage battery 7 in a case where the charge level of the first storage battery 6 is 80%. In another example, the third correction function can calculate a charge power C4 of the second storage battery 7 in a case where the charge level of the first storage battery 6 is 85%. The relationship between the charge power C3 and the charge power C4 is charge power C3<charge power C4.

In a case where the determined priority is neither the first priority, the second priority, nor the third priority, the correction unit 13 does not calculate the correction power. In one example, in a case where the charge level of the first storage battery 6 is “medium” and the charge level of the second storage battery 7 is “medium,” the priority does not correspond to any one of the first priority, the second priority, and the third priority. In this case, the correction unit 13 does not calculate the correction power.

The transfer unit 14 calculates a transfer power for charging and discharging the second storage battery 7 in accordance with some or all of a power value exceeding a predetermined range in a case where the charge and discharge power of the first storage battery 6 exceeds the predetermined range. The charge and discharge power of the first storage battery 6 is, for example, an instantaneous value. The predetermined range is, for example, from 70% of the charge power to 70% of the discharge power, but is not limited to this. The transfer unit 14 may calculate the transfer power such that, for example, half of the power value exceeding the predetermined range is transferred to the second storage battery 7. The transfer unit 14 may calculate the transfer power in a case where the charge power of the first storage battery 6 exceeds the predetermined range. The transfer unit 14 may calculate the transfer power in a case where the discharge power of the first storage battery 6 exceeds the predetermined range.

In one example, in a case where the capacity of the second storage battery 7 is 500 kW of a charge power and 500 kW of a discharge power, the predetermined range may correspond to 350 KW of a charge power and 350 KW of a discharging power. For example, in a case where the instantaneous value of the charge power of the first storage battery 6 is 400 kW, the transfer unit 14 calculates the power value exceeding 350 kW as 50 KW. The transfer unit 14 calculates the transfer power such that some or all of the 50 kW is transferred to the charge power of the second storage battery 7. In another example, in a case where the instantaneous value of the discharge power of the first storage battery 6 is 400 kW, the transfer unit 14 calculates the power value exceeding 350 kW as 50 kW. The transfer unit 14 calculates the transfer power such that some or all of the 50 kW is transferred to the discharge power of the second storage battery 7.

In one example, the transfer unit 14 may calculate the transfer power using a first transfer function in which the greater the charge power of the first storage battery 6 exceeding the predetermined range, the greater the charge power of the second storage battery 7. In one example, the first transfer function can calculate a charge power C5 of the second storage battery 7 in a case where the charge power of the first storage battery 6 is 75%. In another example, the first transfer function can calculate a charge power C6 of the second storage battery 7 in a case where the charge power of the first storage battery 6 is 80%. The relationship between the charge power C5 and the charge power C6 is charge power C5<charge power C6.

In another example, the transfer unit 14 may calculate the transfer power using a second transfer function in which the greater the discharge power of the first storage battery 6 exceeding the predetermined range, the greater the discharge power of the second storage battery 7. In one example, the second transfer function can calculate a discharge power D3 of the second storage battery 7 in a case where the discharge power of the first storage battery 6 is 75%. In another example, the second transfer function can calculate a discharge power D4 of the second storage battery 7 in a case where the discharge power of the first storage battery 6 is 80%. The relationship between the discharge power D3 and the discharge power D4 is discharge power D3<discharge power D4.

In a case where the charge and discharge power of the first storage battery 6 is within the predetermined range, the transfer unit 14 may not calculate the transfer power. In one example, in a case where the charge power of the first storage battery 6 is within the range of 0% to 70% or the discharge power of the first storage battery 6 is within the range of 0% to 70%, the transfer unit 14 may not calculate the transfer power.

The determination unit 15 determines the charge and discharge power of the second storage battery 7 using the differential power between the generated power and the consumed power. For example, the determination unit 15 determines the charge power and the discharge power according to whether the differential power is positive or negative. Here, the explanation will be given assuming that the differential power is calculated by the generated power minus the consumed power. In a case where the differential power is a positive value, the determination unit 15 determines the charge power corresponding to the differential power as the charge and discharge power of the second storage battery 7. In a case where the differential power is a negative value, the determination unit 15 determines the discharge power corresponding to the differential power as the charge and discharge power of the second storage battery 7. The determination unit 15 may limit the charge and discharge power of the second storage battery 7 according to the capacity of the storage battery PCS 71. For example, the determination unit 15 may determine a command upper limit that is the upper limit of the charge and discharge power in the charge and discharge command.

The determination unit 15 may determine the charge and discharge power of the second storage battery 7 using the differential power and the correction power. For example, the determination unit 15 may determine a power value obtained by adding the differential power and the correction power as the charge and discharge power of the second storage battery 7.

The determination unit 15 may determine the charge and discharge power of the second storage battery 7 using the differential power and the transfer power. For example, the determination unit 15 may determine a power value obtained by adding the differential power and the transfer power as the charge and discharge power of the second storage battery 7.

The determination unit 15 may determine the charge and discharge power of the second storage battery 7 using the differential power, the correction power, and the transfer power. For example, the determination unit 15 may determine a power value obtained by adding the differential power, the correction power, and the transfer power as the charge and discharge power of the second storage battery 7.

The control unit 16 transmits the charge and discharge command indicating the determined charge and discharge power to the second storage battery 7. For example, the control unit 16 may transmit the charge and discharge command indicating the charge power to the second storage battery 7. The control unit 16 may transmit the charge and discharge command indicating the discharge power to the second storage battery 7. In a case where the second storage battery 7 is constituted by a plurality of storage batteries, the control unit 16 may determine the allocation of the charge and discharge power to each of the plurality of second storage batteries 7. For example, the control unit 16 may preferentially allocate the charge power to the second storage battery 7 having the lowest charge level among the plurality of second storage batteries 7. The control unit 16 may preferentially allocate the discharge power to the second storage battery 7 having the highest charge level among the plurality of second storage batteries 7.

The limiting unit 17 performs solar power generation output suppression control in the present embodiment. The limiting unit 17 limits the generated power by setting the consumed power as an upper limit value in a case where the charge level of the first storage battery 6 and the charge level of the second storage battery 7 are each equal to or higher than a predetermined value. The predetermined value may be any value that does not result in a fully charged state. The predetermined value is, for example, 80%, but is not limited to this. The upper limit value may be the total value of the consumed power, or may be a moving average of the total values of the consumed power. For example, the limiting unit 17 transmits a command indicating the limit of the generated power to the PCS 51 of the power generation facility 5.

In a case where the PCS 51 is the centralized type, the limiting unit 17 transmits a command to limit the upper limit value of the generated power by the plurality of solar panels 52 to the PCS 51. The centralized type of PCS 51 limits the upper limit value of the generated power according to the command.

In a case where the PCS 51 is the distributed type, the limiting unit 17 calculates a power generation capability that is the power that can be generated by the plurality of solar panels 52. The limiting unit 17 calculates the power generation capability using, for example, an illuminance, a temperature, a power generation amount of the plurality of solar panels 52, and the like. The limiting unit 17 calculates an activation upper limit, which is the upper limit number of the plurality of PCSs 51 to be activated, such that the calculated power generation capability does not exceed the upper limit value. The limiting unit 17 transmits a command indicating control of activating or stopping the plurality of PCSs 51 to each of the plurality of PCSs 51. The distributed type of PCS 51 performs activating or stopping according to the command.

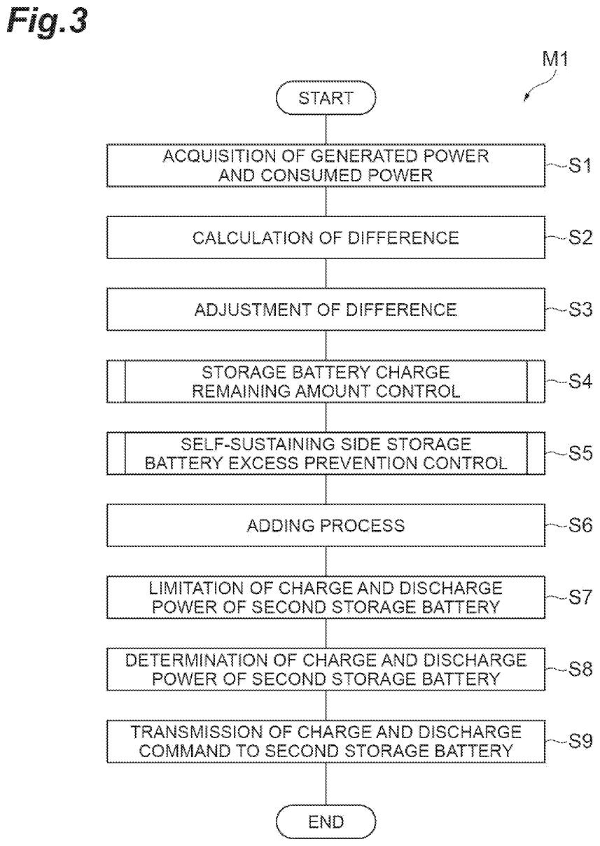

The operation of the control device 10 will be explained with reference to FIGS. 3 to 5, and an example of a control method will be explained. FIG. 3 is a flowchart showing an example of a process of the control device 10 as process flow M1.

In FIG. 3, the smart grid 2 will be described on the assumption that after the connection with the power system 3 is cut off, a pre-process for starting the self-sustaining operation has been performed. For example, when the connection between the smart grid 2 and the power system 3 is cut off, a power outage occurs in the smart grid 2. As a first step of the pre-process, the control device 10 activates the first storage battery 6 and controls the voltage of the smart grid 2 to be a target value. As a second step of the pre-process, the control device 10 transmits a charge and discharge command indicating charge to the second storage battery 7. The second storage battery 7 functions as a pseudo load by performing charge. As a third step of the pre-process, the control device 10 activates the power generation facility 5. Inside the smart grid 2, the load 8 starts consuming a power.

In step S1, the acquisition unit 11 acquires the generated power in the smart grid 2 and the consumed power in the smart grid 2. For example, the acquisition unit 11 acquires the generated power of the power generation facility 5 from the power generation facility 5. For example, the acquisition unit 11 acquires the consumed power of the load 8 from the instantaneous power meter 9. The acquisition unit 11 may acquire the consumed power of each of the plurality of loads 8 from each of the plurality of instantaneous power meters 9.

In step S2, the calculation unit 12 calculates a difference between the generated power and the consumed power. The calculation unit 12 calculates a difference between the generated power and the consumed power. For example, the calculation unit 12 calculates a difference between the generated power of the power generation facility 5 and a total value of the consumed power by the plurality of loads 8.

In step S3, the calculation unit 12 adjusts a difference between the generated power and the consumed power. For example, the calculation unit 12 calculates the differential power by adjusting the difference. The calculation unit 12 may multiply the difference by a gain coefficient G. The calculation unit 12 may multiply the difference by a gain coefficient G and an integral coefficient. The calculation unit 12 may apply a rate limiter for limiting the rate of change to the difference. The calculation unit 12 may perform adjustment such that the value does not change before and after adjusting the difference, or may not perform adjustment.

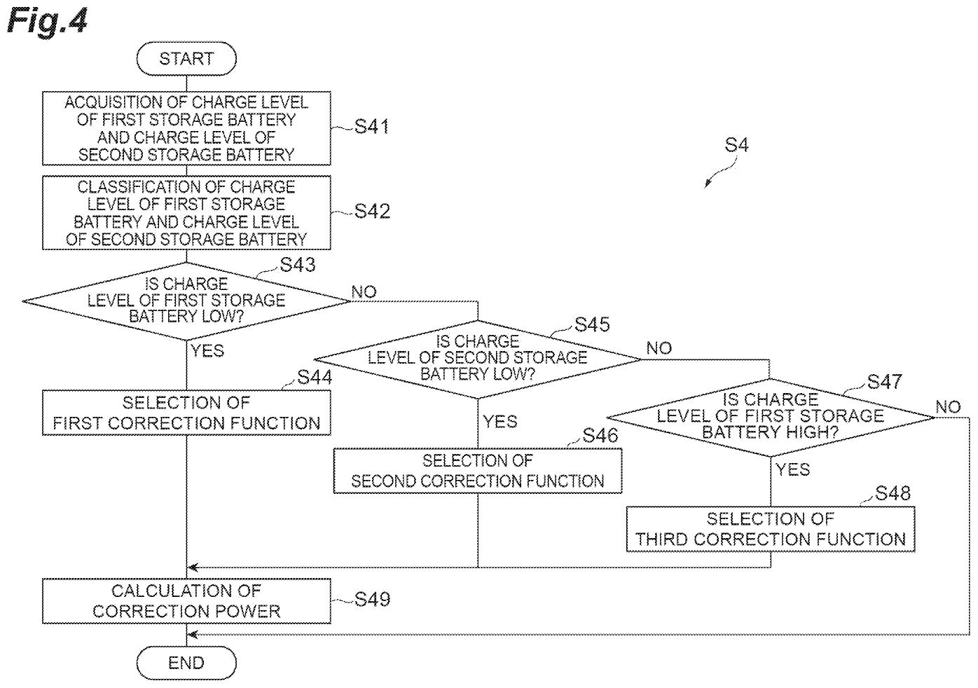

In step S4, the control device 10 performs storage battery charge remaining amount control. An example of the storage battery charge remaining amount control will be described with reference to FIG. 4. FIG. 4 is a flowchart showing an example of the storage battery charge remaining amount control. For example, in the storage battery charge remaining amount control, a correction power for bringing the charge level of the first storage battery 6 closer to a prescribed range (for example, 50% to 75%) is calculated. Alternatively, in the storage battery charge remaining amount control, a correction power for bringing the charge level of the second storage battery 7 closer to a prescribed value or higher (for example, 25% or higher) is calculated. In other words, in the storage battery charge remaining amount control, the charge level of the first storage battery 6 and the charge level of the second storage battery 7 are stabilized.

In step S41, the acquisition unit 11 acquires the charge level of the first storage battery 6 and the charge level of the second storage battery 7. For example, the acquisition unit 11 acquires the charge level of the first storage battery 6 from the first storage battery 6. The acquisition unit 11 acquires the charge level of the second storage battery 7 from the second storage battery 7.

In step S42, the correction unit 13 classifies the charge level of the first storage battery 6 and the charge level of the second storage battery 7. For example, the correction unit 13 classifies the charge level of the first storage battery 6 into any one of “high,” “medium,” and “low” using a threshold value. In one example, the correction unit 13 classifies the charge level of the first storage battery 6 into “high” in a case where it is higher than 75%, “medium” in a case where it is 50% to 75%, or “low” in a case where it is lower than 50%. Similarly, the correction unit 13 classifies the charge level of the second storage battery 7 into any one of “high,” “medium,” and “low” using a threshold value.

In step S43, the correction unit 13 determines whether or not the charge level of the first storage battery 6 is low. In a case where the charge level of the first storage battery 6 is “low” (step S43: YES), the process proceeds to step S44. In a case where the charge level of the first storage battery 6 is “medium” or “high” (step S43: NO), the process proceeds to step S45.

In step S44, the correction unit 13 selects a first correction function in which the lower the charge level of the first storage battery 6, the greater the discharge power of the second storage battery 7.

In step S45, the correction unit 13 determines whether or not the charge level of the second storage battery 7 is low. In a case where the charge level of the second storage battery 7 is “low” (step S45: YES), the process proceeds to step S46. In a case where the charge level of the second storage battery 7 is “medium” or “high” (step S45: NO), the process proceeds to step S47.

In step S46, the correction unit 13 selects a second correction function in which the lower the charge level of the second storage battery 7, the greater the charge power of the second storage battery 7.

In step S47, the correction unit 13 determines whether or not the charge level of the first storage battery 6 is high. In a case where the charge level of the first storage battery 6 is “high” (step S47: YES), the process proceeds to step S48. In a case where the charge level of the first storage battery 6 is “medium” (step S47: NO), the process of step S4 ends.

In step S48, the correction unit 13 calculates the correction power using a third correction function in which the higher the charge level of the first storage battery 6, the greater the charge power of the second storage battery 7.

In step S49, the correction unit 13 calculates the correction power. For example, the correction unit 13 calculates the correction power using the correction function selected from among the first correction function, the second correction function, and the third correction function. In one example, the correction unit 13 calculates the discharge power of the second storage battery 7 as the correction power using the selected first correction function. In another example, the correction unit 13 calculates the charge power of the second storage battery 7 as the correction power using the selected second correction function. In another further example, the correction unit 13 calculates the charge power of the second storage battery 7 as the correction power using the selected third correction function.

In the storage battery charge remaining amount control in step S4, in a case where the charge level of the first storage battery 6 is not 50% to 75% or in a case where the charge level of the second storage battery 7 is 25% or less, the correction power is calculated.

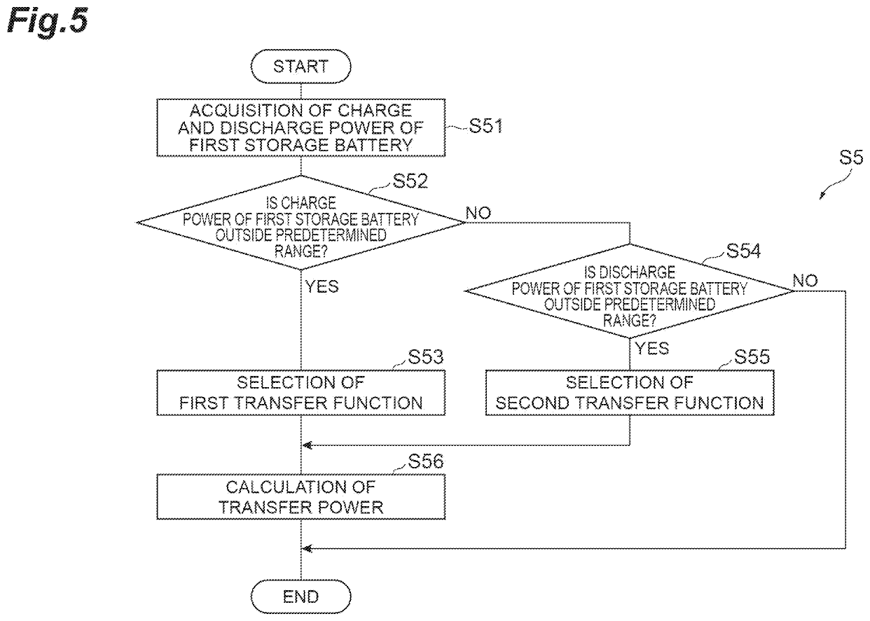

In step S5 shown in FIG. 3, the control device 10 performs self-sustaining side storage battery excess prevention control. An example of the self-sustaining side storage battery excess prevention control will be described with reference to FIG. 5. FIG. 5 is a flowchart illustrating an example of the self-sustaining side storage battery excess prevention control. For example, in the self-sustaining side storage battery excess prevention control, the transfer power for transferring the charge and discharge power of the first storage battery 6 exceeding the predetermined range to the second storage battery 7 is calculated. In the self-sustaining side storage battery excess prevention control, the excessive charge and discharge power of the first storage battery 6 is transferred to the second storage battery 7, and thus abnormal stoppage of the first storage battery 6 is prevented.

In step S51, the acquisition unit 11 acquires the charge and discharge power of the first storage battery 6 from the first storage battery 6. The acquired charge and discharge power of the first storage battery 6 is, for example, an instantaneous value.

In step S52, the transfer unit 14 determines whether or not the charge power of the first storage battery 6 exceeds a predetermined range. In one example, the predetermined range is, for example, 70% of the charge power. In this case, the transfer unit 14 determines whether or not the charge power of the first storage battery 6 exceeds 70%. In a case where the charge power of the first storage battery 6 exceeds the predetermined range (step S52: YES), the process proceeds to step S53. In a case where the charge power of the first storage battery 6 does not exceed the predetermined range (step S52: NO), the process proceeds to step S54.

In step S53, the transfer unit 14 selects a first transfer function in which the greater the charge power of the first storage battery 6 exceeding the predetermined range, the greater the charge power of the second storage battery 7.

In step S54, the transfer unit 14 determines whether or not the discharge power of the first storage battery 6 exceeds a predetermined range. In one example, the predetermined range is, for example, 70% of the discharge power. In this case, the transfer unit 14 determines whether or not the discharge power of the first storage battery 6 exceeds 70%. In a case where the discharge power of the first storage battery 6 exceeds the predetermined range (step S54: YES), the process proceeds to step S55. In a case where the discharge power of the first storage battery 6 does not exceed the predetermined range (step S54: NO), the process of step S5 ends.

In step S55, the transfer unit 14 selects a second transfer function in which the greater the discharge power of the first storage battery 6 exceeding the predetermined range, the greater the discharge power of the second storage battery 7.

In step S56, the transfer unit 14 calculates the transfer power. For example, the transfer unit 14 calculates the transfer power using the transfer function selected from among the first transfer function and the second transfer function. In one example, the transfer unit 14 calculates the charge power of the second storage battery 7 as the transfer power using the selected first transfer function. In another example, the transfer unit 14 calculates the discharge power of the second storage battery 7 as the transfer power using the selected second transfer function.

Returning to FIG. 3, in step S6, the determination unit 15 adds the differential power, the correction power, and the transfer power. The correction power may not be calculated in the storage battery charge remaining amount control in step S4 and may be 0. In this case, the determination unit 15 may not perform the addition using the correction power. The transfer power may not be calculated in the self-sustaining side storage battery excess prevention control in step S5 and may be 0. In this case, the determination unit 15 may not perform the addition using the transfer power.

In step S7, the determination unit 15 limits the charge and discharge power of the second storage battery 7 in the charge and discharge command. For example, the determination unit 15 determines a command upper limit according to the capacity of the storage battery PCS 71. In one example, in a case where the capacity of the storage battery PCS 71 is 500 kW of a charge power and 500 kW of a discharge power, the command upper limit may be equal to or less than 500 kW of a charge power and 500 kW of a discharging power.

In step S8, the determination unit 15 determines the charge and discharge power of the second storage battery 7 using the differential power. The determination unit 15 determines the charge power and the discharge power according to whether the differential power is positive or negative. Here, the explanation will be given assuming that the differential power is calculated by the generated power minus the consumed power. In a case where the differential power is a positive value, the determination unit 15 determines the charge power corresponding to the differential power as the charge and discharge power of the second storage battery 7. In a case where the differential power is a negative value, the determination unit 15 determines the discharge power corresponding to the differential power as the charge and discharge power of the second storage battery 7.

The determination unit 15 may determine the charge and discharge power of the second storage battery 7 using the differential power and the correction power. For example, the determination unit 15 may determine a power value obtained by adding the differential power and the correction power in step S6 as the charge and discharge power of the second storage battery 7.

The determination unit 15 may determine the charge and discharge power of the second storage battery 7 using the differential power and the transfer power. For example, the determination unit 15 may determine a power value obtained by adding the differential power and the transfer power in step S6 as the charge and discharge power of the second storage battery 7.

The determination unit 15 may determine the charge and discharge power of the second storage battery 7 using the differential power, the correction power, and the transfer power. For example, the determination unit 15 may determine a power value obtained by adding the differential power, the correction power, and the transfer power in step S6 as the charge and discharge power of the second storage battery 7.

In step S9, the control unit 16 transmits the charge and discharge command indicating the determined charge and discharge power to the second storage battery 7. For example, the control unit 16 may transmit the charge and discharge command indicating the charge power to the second storage battery 7. The control unit 16 may transmit the charge and discharge command indicating the discharge power to the second storage battery 7. In a case where the second storage battery 7 is constituted by a plurality of storage batteries, the control unit 16 may determine the allocation of the charge and discharge power to each of the plurality of second storage batteries 7. For example, the control unit 16 may preferentially allocate the charge power to the second storage battery 7 having the lowest charge level among the plurality of second storage batteries 7. The control unit 16 may preferentially allocate the discharge power to the second storage battery 7 having the highest charge level among the plurality of second storage batteries 7.

In the process flow M1, the process of step S4 and step S5 may be performed in any order before step S6. At least one process of step S4 and step S5 may be omitted. After the process of step S9, the acquisition unit 11 may acquire the charge levels of the plurality of second storage batteries 7. The control unit 16 may perform feedback using the charge levels of the plurality of second storage batteries 7 and determine the allocation of the charge and discharge power to each of the plurality of second storage batteries 7. After the process of step S9, the control device 10 may perform the storage battery charge remaining amount control of step S4.

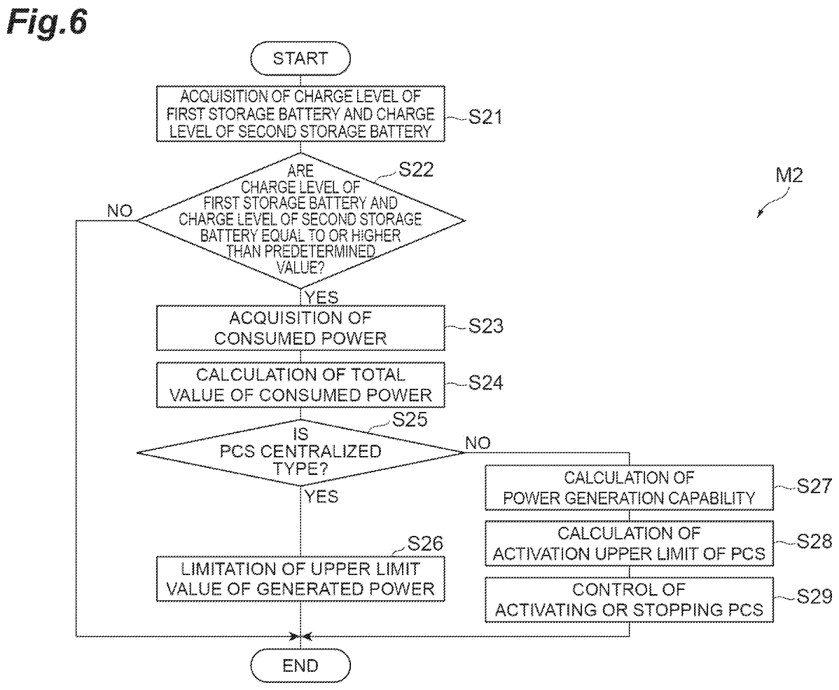

An example of the solar power generation output suppression control will be described with reference to FIG. 6. FIG. 6 is a flowchart showing an example of the solar power generation output suppression control as process flow M2. The process flow M2 may be incorporated or may not be incorporated into the process flow M1. The process flow M2 may be performed independently of the process flow M1. For example, in the solar power generation output suppression control, the power generation facility 5 is controlled such that the charge level of the first storage battery 6 and the charge level of the second storage battery 7 are brought closer to a predetermined value (for example, 80%) or less.

In step S21, the acquisition unit 11 acquires the charge level of the first storage battery 6 and the charge level of the second storage battery 7. For example, the acquisition unit 11 acquires the charge level of the first storage battery 6 from the first storage battery 6. The acquisition unit 11 acquires the charge level of the second storage battery 7 from the second storage battery 7.

In step S22, the limiting unit 17 determines whether or not the charge level of the first storage battery 6 and the charge level of the second storage battery 7 are each equal to or higher than a predetermined value. The predetermined value is, for example, 80%, but is not limited to this. In a case where the charge level of the first storage battery 6 and the charge level of the second storage battery 7 are each equal to or higher than the predetermined value (step S22: YES), the process proceeds to step S23. In a case where at least one of the charge level of the first storage battery 6 and the charge level of the second storage battery 7 is less than the predetermined value (step S22: NO), the process flow M2 ends.

In step S23, the acquisition unit 11 acquires the consumed power in the smart grid 2. For example, the acquisition unit 11 acquires the consumed power of the load 8 from the instantaneous power meter 9. The acquisition unit 11 may acquire the consumed power of each of the plurality of loads 8 from each of the plurality of instantaneous power meters 9.

In step S24, the limiting unit 17 calculates the total value of the consumed power. The limiting unit 17 may calculate a moving average of the total values of the consumed power.

In step S25, the limiting unit 17 distributes the process depending on whether or not the PCS 51 is the centralized type. In a case where the PCS 51 is the centralized type (step S25: YES), the process proceeds to step S26. In a case where the PCS 51 is the distributed type (step S25: NO), the process proceeds to step S27.

In step S26, the limiting unit 17 transmits a command to limit the upper limit value of the generated power by the plurality of solar panels 52 to the PCS 51. The centralized type of PCS 51 limits the upper limit value of the generated power according to the command.

In step S27, the limiting unit 17 calculates the power generation capability. The limiting unit 17 calculates the power generation capability using, for example, an illuminance, a temperature, a power generation amount of the plurality of solar panels 52, and the like.

In step S28, the limiting unit 17 calculates an activation upper limit of the plurality of PCSs 51 such that the calculated power generation capability does not exceed the upper limit value of the generated power. The limiting unit 17 may use the number of activated PCSs 51 at the current time to calculate the activation upper limit.

In step S29, the limiting unit 17 transmits a command indicating control of activating or stopping the plurality of PCSs 51 to each of the plurality of PCSs 51. The distributed type of PCS 51 performs activating or stopping according to the command.

### [Hardware Configuration]

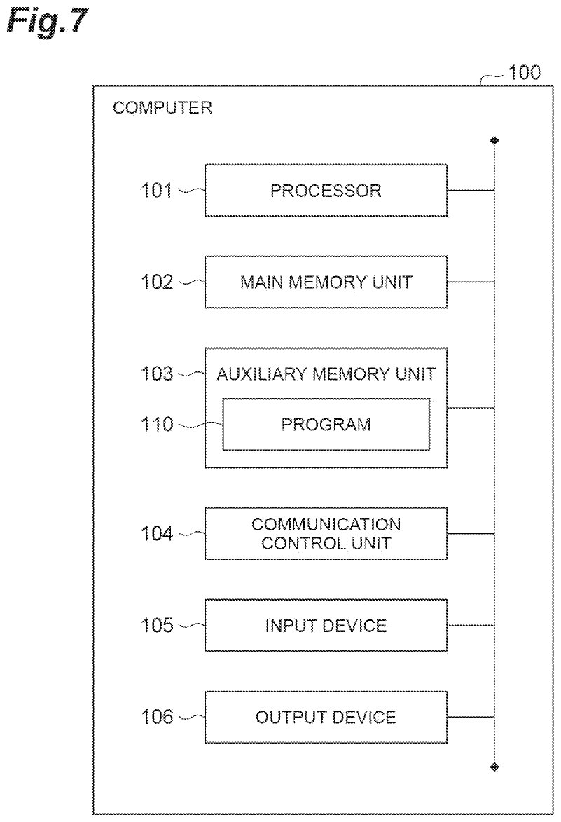

FIG. 7 is a diagram illustrating an example of a hardware configuration related to the control system 1. FIG. 7 illustrates a computer 100 functioning as the control device 10. The computer 100 includes at least one processor 101, a main memory unit 102, an auxiliary memory unit 103, a communication control unit 104, an input device 105, and an output device 106. The control device 10 is constituted by one or a plurality of computers 100 constituted by these pieces of hardware and software such as a program.

In a case where the control device 10 is constituted by a plurality of computers 100, these computers 100 may be locally connected or may be connected via a communication network such as the Internet or an intranet. With this connection, one control device 10 is logically constructed.

The processor 101 executes an operating system, an application program, and the like. The processor 101 is, for example, a central processing unit (CPU). The main memory unit 102 is constituted by a read only memory (ROM) and a random access memory (RAM). The auxiliary memory unit 103 is a memory medium constituted by a hard disk, a flash memory, or the like. Generally, the auxiliary memory unit 103 holds a larger amount of data than the main memory unit 102. The communication control unit 104 is constituted by a network card or a wireless communication module. At least a part of the communication function of the control device 10 with another device may be implemented by the communication control unit 104. The input device 105 is constituted by a keyboard, a mouse, a touch panel, a microphone for voice input, and the like. The output device 106 is constituted by a display, a printer, and the like.

In the auxiliary memory unit 103, a program 110 (control program) and data to be executed are saved in advance. The program 110 causes the computer 100 to execute each functional element of the control device 10. For example, the processing relating to the control method described above is executed in the computer 100 by the program 110. For example, the program 110 is read by the processor 101 or the main memory unit 102 and operates at least one of the processor 101, the main memory unit 102, the auxiliary memory unit 103, the communication control unit 104, the input device 105, and the output device 106. For example, the program 110 reads and writes data from and into the main memory unit 102 and the auxiliary memory unit 103.

The program 110 may be provided after being recorded on a tangible memory medium or a non-transitory computer-readable recording medium such as a CD-ROM, a DVD-ROM, or a semiconductor memory, for example. The program 110 may be provided as a data signal via a communication network.

A control device 10 according to one aspect of the present disclosure is a control device 10 that supports self-sustaining operation of a smart grid 2 which includes a power generation facility that performs power generation using renewable energy, a first storage battery 6 that controls a voltage of the smart grid 2 to be a target value, and a second storage battery 7 that performs charge and discharge according to a charge and discharge command. The control device 10 includes: an acquisition unit 11 configured to acquire a generated power in the smart grid 2 and a consumed power in the smart grid 2; a calculation unit 12 configured to calculate a differential power that is a difference between the generated power and the consumed power; a determination unit 15 configured to determine a charge and discharge power of the second storage battery 7 using the differential power; and a control unit 16 configured to transmit the charge and discharge command indicating the determined charge and discharge power of the second storage battery 7 to the second storage battery 7.

A control method according to one aspect of the present disclosure is a control method executed by a control device 10 that supports self-sustaining operation of a smart grid 2 which includes a power generation facility that performs power generation using renewable energy, a first storage battery 6 that controls a voltage of the smart grid 2 to be a target value, and a second storage battery 7 that performs charge and discharge according to a charge and discharge command. The control method includes: acquiring a generated power in the smart grid 2 and a consumed power in the smart grid 2; calculating a differential power that is a difference between the generated power and the consumed power; determining a charge and discharge power of the second storage battery 7 using the differential power; and transmitting the charge and discharge command indicating the determined charge and discharge power of the second storage battery 7 to the second storage battery 7.

In the control device 10 and the control method, in the self-sustaining operation of the smart grid 2, the charge and discharge power of the second storage battery 7 is determined using the differential power that is the difference between the generated power and the consumed power. The charge and discharge of the second storage battery 7 is performed according to the charge and discharge command indicating the determined charge and discharge power of the second storage battery 7. Through the charge and discharge of the second storage battery 7, the differential power is eliminated proactively. The fluctuation in the voltage of the smart grid 2 due to the differential power is suppressed. As a result, the operation of the first storage battery 6 that controls the voltage of the smart grid 2 to be the target value is stabilized. As a result, it is possible to stably operate the self-sustaining operation of the smart grid 2.

The acquisition unit 11 acquires the charge level of the first storage battery 6 and the charge level of the second storage battery 7. The control device 10 further includes the correction unit that calculates the correction power for charging and discharging the second storage battery 7 in accordance with a priority of the charge level of the first storage battery 6 and the charge level of the second storage battery 7. The determination unit 15 determines the charge and discharge power of the second storage battery 7 using the differential power and the correction power. According to such a configuration, the correction power calculated according to the charge level of the first storage battery 6 and the charge level of the second storage battery 7 is reflected in the charge and discharge power of the second storage battery 7. As a result, it becomes easy to control the charge level of the first storage battery 6 and the charge level of the second storage battery 7 through the charge and discharge of the second storage battery 7. As a result, it is possible to more stably operate the self-sustaining operation of the smart grid 2.

The acquisition unit 11 acquires the charge and discharge power of the first storage battery 6. The control device 10 further includes the transfer unit that calculates the transfer power for charging and discharging the second storage battery 7 in accordance with some or all of a power value exceeding a predetermined range in a case where the charge and discharge power of the first storage battery 6 exceeds the predetermined range. The determination unit 15 determines the charge and discharge power of the second storage battery 7 using the differential power and the transfer power. According to such a configuration, the transfer power calculated according to the charge and discharge power of the first storage battery 6 exceeding the predetermined range is reflected in the charge and discharge power of the second storage battery 7. That is, some or all of the power value exceeding the predetermined range is transferred to the charge and discharge power of the second storage battery 7. As a result, the charge and discharge power of the first storage battery 6 can be prevented from becoming excessive, and thus the operation of the first storage battery 6 is stabilized. As a result, it is possible to more stably operate the self-sustaining operation of the smart grid 2.

The acquisition unit 11 acquires the charge level of the first storage battery 6 and the charge level of the second storage battery 7. The control device 10 further includes the limiting unit 17 that limits the generated power by setting the consumed power as an upper limit value in a case where the charge level of the first storage battery 6 and the charge level of the second storage battery 7 are each equal to or higher than a predetermined value. According to such a configuration, in a case where the charge level of the first storage battery 6 and the charge level of the second storage battery 7 are equal to or higher than the predetermined value, the generated power is limited by setting the consumed power as an upper limit value. For example, when both the first storage battery 6 and the second storage battery 7 are fully charged, it becomes difficult to continue the self-sustaining operation. By limiting the generated power, it is possible to prevent the charge level of the first storage battery 6 and the charge level of the second storage battery 7 from being equal to or higher than the predetermined value. As a result, it is possible to more stably operate the self-sustaining operation of the smart grid 2.

### Modification Example

The present disclosure is not necessarily limited to the embodiments described above, and various changes can be made without departing from the gist thereof. For example, the power generation facility 5 may not be a facility in the smart grid 2.

In the comparison of the magnitude relationship between two numerical values, either of the two criteria “equal to or greater than” and “exceeding (greater than)” may be used, or either of the two criteria “equal to or less than” and “less than” may be used.

In the present disclosure, an expression “at least one processor executes a first process, executes a second process, . . . , and executes an n-th process” or an expression corresponding to this is a concept that includes a case where the main executing component (that is, the processor) of n processes from the first process to the nth process changes through the processes. That is, this expression is a concept that includes both a case where all of the n processes are executed by the same processor, and a case where the processor is changed according to an arbitrary policy in the n processes.

The process procedure of the method executed by at least one processor is not limited to the example in the above embodiment. For example, some of the steps (the processes) described above may be omitted, or each step may be executed in a different order. Furthermore, any two or more of the steps described above may be combined with each other, or some of the steps may be modified or deleted. Alternatively, other steps may be executed in addition to each of the above steps.

The gist of the present disclosure is shown below.

[1]

A control device that supports self-sustaining operation of a smart grid which includes a power generation facility that performs power generation using renewable energy, a first storage battery that controls a voltage of the smart grid to be a target value, and a second storage battery that performs charge and discharge according to a charge and discharge command, the control device comprising:
an acquisition unit configured to acquire a generated power in the smart grid and a consumed power in the smart grid;
a calculation unit configured to calculate a differential power that is a difference between the generated power and the consumed power;
a determination unit configured to determine a charge and discharge power of the second storage battery using the differential power; and
a control unit configured to transmit the charge and discharge command indicating the determined charge and discharge power of the second storage battery to the second storage battery.
   [2]

The control device according to [1],
wherein the acquisition unit is further configured to acquire a charge level of the first storage battery and a charge level of the second storage battery,
wherein the control device further comprises a correction unit configured to calculate a correction power for charging and discharging the second storage battery in accordance with a priority of the charge level of the first storage battery and the charge level of the second storage battery, and
wherein the determination unit is configured to determine the charge and discharge power of the second storage battery using the differential power and the correction power.
   [3]

The control device according to [1] or [2],
wherein the acquisition unit is further configured to acquire a charge and discharge power of the first storage battery,
wherein the control device further comprises a transfer unit configured to calculate a transfer power for charging and discharging the second storage battery in accordance with some or all of a power value exceeding a predetermined range in a case where the charge and discharge power of the first storage battery exceeds the predetermined range, and
wherein the determination unit is configured to determine the charge and discharge power of the second storage battery using the differential power and the transfer power.
   [4]

The control device according to any one of [1] to [3],
wherein the acquisition unit is further configured to acquire a charge level of the first storage battery and a charge level of the second storage battery, and
wherein the control device further comprises a limiting unit configured to limit the generated power by setting the consumed power as an upper limit value in a case where the charge level of the first storage battery and the charge level of the second storage battery are each equal to or higher than a predetermined value.
   [5]

A control method executed by a control device that supports self-sustaining operation of a smart grid which includes a power generation facility that performs power generation using renewable energy, a first storage battery that controls a voltage of the smart grid to be a target value, and a second storage battery that performs charge and discharge according to a charge and discharge command, the control method comprising:
acquiring a generated power in the smart grid and a consumed power in the smart grid;
calculating a differential power that is a difference between the generated power and the consumed power;
determining a charge and discharge power of the second storage battery using the differential power; and
transmitting the charge and discharge command indicating the determined charge and discharge power of the second storage battery to the second storage battery.

What is claimed is:

1. A control device that supports self-sustaining operation of a smart grid which includes a power generation facility that performs power generation using renewable energy, a first storage battery that controls a voltage of the smart grid to be a target value, and a second storage battery that performs charge and discharge according to a charge and discharge command, the control device comprising:
an acquisition unit configured to acquire a generated power in the smart grid and a consumed power in the smart grid;
a calculation unit configured to calculate a differential power that is a difference between the generated power and the consumed power;
a determination unit configured to determine a charge and discharge power of the second storage battery using the differential power; and
a control unit configured to transmit the charge and discharge command indicating the determined charge and discharge power of the second storage battery to the second storage battery.

2. The control device according to claim 1,
wherein the acquisition unit is further configured to acquire a charge level of the first storage battery and a charge level of the second storage battery,
wherein the control device further comprises a correction unit configured to calculate a correction power for charging and discharging the second storage battery in accordance with a priority of the charge level of the first storage battery and the charge level of the second storage battery, and
wherein the determination unit is configured to determine the charge and discharge power of the second storage battery using the differential power and the correction power.

3. The control device according to claim 1,
wherein the acquisition unit is further configured to acquire a charge and discharge power of the first storage battery,
wherein the control device further comprises a transfer unit configured to calculate a transfer power for charging and discharging the second storage battery in accordance with some or all of a power value exceeding a predetermined range in a case where the charge and discharge power of the first storage battery exceeds the predetermined range, and
wherein the determination unit is configured to determine the charge and discharge power of the second storage battery using the differential power and the transfer power.

4. The control device according to claim 1,
wherein the acquisition unit is further configured to acquire a charge level of the first storage battery and a charge level of the second storage battery, and
wherein the control device further comprises a limiting unit configured to limit the generated power by setting the consumed power as an upper limit value in a case where the charge level of the first storage battery and the charge level of the second storage battery are each equal to or higher than a predetermined value.

5. A control method executed by a control device that supports self-sustaining operation of a smart grid which includes a power generation facility that performs power generation using renewable energy, a first storage battery that controls a voltage of the smart grid to be a target value, and a second storage battery that performs charge and discharge according to a charge and discharge command, the control method comprising:
acquiring a generated power in the smart grid and a consumed power in the smart grid;
calculating a differential power that is a difference between the generated power and the consumed power;
determining a charge and discharge power of the second storage battery using the differential power; and
transmitting the charge and discharge command indicating the determined charge and discharge power of the second storage battery to the second storage battery.
